(19) United States
(12) Patent Application Publication
(10) Pub. No.: US 2018/0211259 A1
(43) Pub. Date: Jul. 26, 2018

(54) Artificial Intelligence Based Customer Service and Social Media Method

(71) Applicants: Quyen Trong Vu, San Jose, CA (US); Rudy Alberto Rios, Fremont, CA (US)

(72) Inventors: Quyen Trong Vu, San Jose, CA (US); Rudy Alberto Rios, Fremont, CA (US)

(21) Appl. No.: 15/413,189

(22) Filed: Jan. 23, 2017

(51) Int. Cl. G06Q 30/00; G06Q 50/00; G06Q 10/08; G06N 5/02

(52) U.S. Cl. CPC G06Q 30/016; G06N 5/022; G06Q 10/087; G06Q 50/01

(57) ABSTRACT

A customer service method includes geolocating devices and users verifying the geolocation of the device. The user selects a search proximity based on the geolocation of the devices, to identify businesses within the search proximity. A list of the businesses is presented, which are selected by the user. The devices communicate with a first network within the business network, which presents chat rooms. Chat rooms are created by the business and by the consumers. Each chat room communicates with a second network, wherein the second network is adaptive based on user input and is able to generate a response based on user input. At least one user is a manager of a business who is able to audit the second network response. A main server, main database, internal artificial intelligence bot, and external artificial intelligence bot are in communication with the devices.

### BACKGROUND OF THE INVENTION

### 1. Field of Invention

The present invention relates to the field of software applications that connect local businesses with local clients using both artificial intelligence bots and the community of users.

### 2. Description of Related Art

Recent development in software and the entire technology field have brought consumers closer to businesses, both local and international, online and offline. For online, it is now easier than ever to find specific services like promotions, special offers, and real-time product information on business web sites. Consumers can connect with businesses by visiting the business site or by visiting a number of other websites that review or summarize a business and its services. Further, consumers can visit applications and websites that provide reviews by other consumers. These websites offer great information regarding metrics of the business that provides conveniences to online users. This information is useful, however, it is not relevant and incompatible with metrics for offline local businesses such as the “feel and touch” of products which the local brick-and-mortar businesses provide as well as the hassle-free of “shipping and returning” which online users encounter.

For local, offline businesses, consumers still love the shopping environment. However, it does have disadvantages regarding realtime inventory updates or customer services. While it is possible to simply call or email the business and ask any questions the consumer may have, this requires a large input of resources by the business.

Further, questions may not be answerable immediately. Any questions by consumers at physical local stores requires resources, time and sometimes result brings frustration to consumers.

Artificial intelligence bots are rising in popularity as the technology continues to advance. The idea is to incorporate artificial intelligence into businesses and everyday life as a vehicle of performing mundane tasks, thus saving people time and money. For example, artificial intelligence bots can be used to answer basic questions by a consumer, saving employee time and resources for face-to-face clients and other creative tasks.

Based on the foregoing, there is a need in the art for a software application that combines social interaction between users with the convenience and real-time accuracy of artificial intelligence bots to better connect a consumer with a local, brick-and-mortar business.

### SUMMARY OF THE INVENTION

A customer service method comprises the steps of geolocating one or more devices, then the user verifying the geolocating. The user then selects a search proximity based on the confirmed geolocation of the one or more devices. One or more businesses are identified and presented as determined by the search proximity. The user then selects one or more businesses from the search list.

In an embodiment, the devices communicate with a first network within the selected business network. The first network presents one or more chat rooms to be displayed on the devices. The users then engage the one or more chat rooms and the chat rooms communicate information to a second network. The second network is adaptable based on user input and is able to generate a response to the users input automatically.

In an embodiment, at least one user is a manager, wherein the manager audits the response generated by the second network.

In an embodiment, the second network searches a product inventory list, a business information list, and business pricing list as necessitated by the user.

In an embodiment, a main server, main database, internal artificial intelligence bot, and external artificial intelligence bot are in communication with the devices, first network, and second network. Each element is able to send and receive information to and from one another. In an embodiment, the internal artificial intelligence bot is in communication with the device using an extensible messaging and presence protocol.

In an embodiment, the chat rooms are creatable by both businesses and consumers users.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flowchart of the system, according to an embodiment of the present invention; and

FIG. 2 is a flowchart of the system, according to an embodiment of the present invention.

### DETAILED DESCRIPTION OF PREFERRED EMBODIMENTS

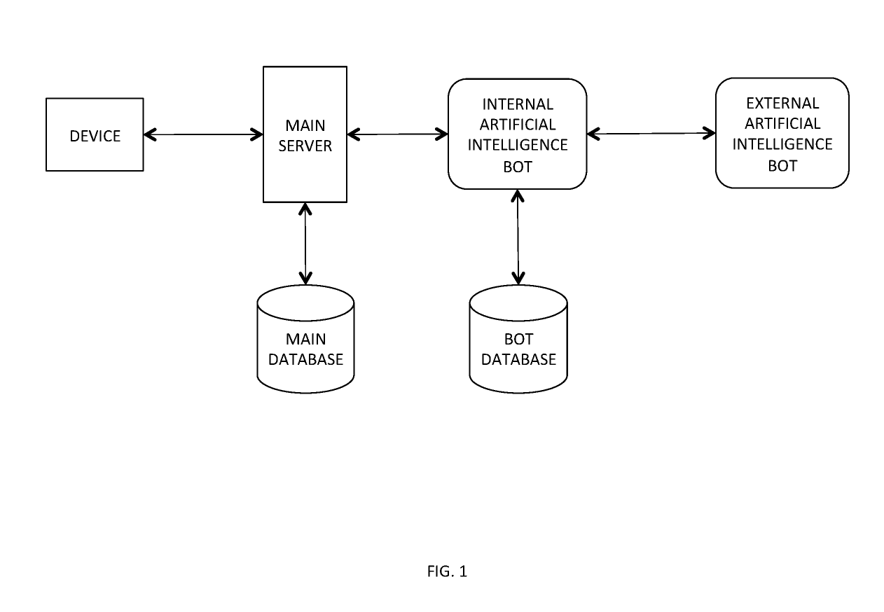

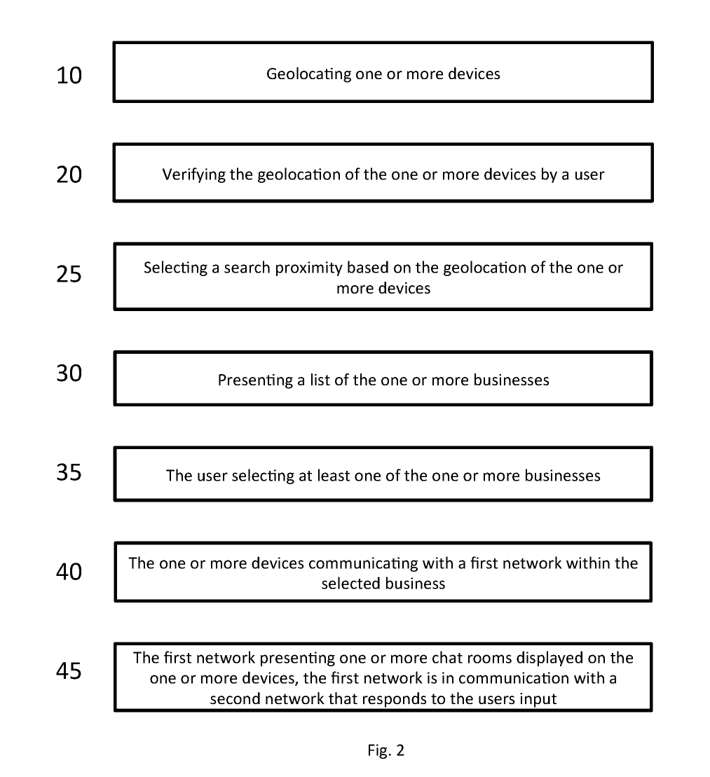

Preferred embodiments of the present invention and their advantages may be understood by referring to FIGS. 1-2, wherein like reference numerals refer to like elements.

The present invention, in general, has two main features. In the following description, a user may refer to a consumer or a business. The first main feature is a local social network, in which users can choose to disclose interests so that other users may search these interests and connect with them and vice versa.

In use, the user will set up a profile, requiring log in credentials. In an embodiment, the software application is integrated with location software, allowing the application to track the location of the user in real-time and display information according to the changing location of the user. This only occurs if the user selects to disclose their profiles publicly, otherwise, no location data is collected and the user profile is not visible or searchable.

Once profiles are set to the visible setting, users can connect, engage in conversations, and receive help throughout the community of users via chat rooms or one-on-one with other user. The entire software application is proximity dependent, meaning that users are only connected with each other based on proximity settings determined by the user during the search query. For example, a user can select to only connect with consumers or businesses from 0.25 to 25 mile radius of their current location. This provides the greatest opportunity for relevant and immediately actionable search results.

The second main feature of the software application is artificial intelligent bots for brick-and-mortar businesses. Businesses have the added advantage of creating a chat rooms, where prospective and prior consumers can engage with one another by asking and answering questions, providing reviews, and providing other useful information regarding the business. In addition, the business could also add the artificial intelligent bots into their local business chat rooms to answer any questions regarding sale information, product promotions, updated services, or other information.

In an embodiment, users download the software application on a mobile device or computer, herein referred to as device. The device is in communication with a dedicated main server of the software application. Data is shared between the device and the main server, allowing for data information to be sent to and from each entity. The device and main server are in communication via the utilization of Representational State Transfer (RESTful) web service.

In an embodiment, the business could create their own chat rooms which are visible and searchable for consumers who are at proximity of the physical location of businesses. The businesses could also add artificial intelligence bots into the chat rooms to answer any questions that consumers may have. The artificial intelligence bot can access the inventory of the business. This allows the artificial intelligence bot to answer consumer questions immediately, without the need to use business employee time and resources. This method ensures that the customers' answers are always answered accurately by reducing human error. The artificial intelligence bot is able to learn based on previously answered questions, resulting in faster and more accurate answers in the future.

In an embodiment, each artificial intelligence bot is able to accomplish multiple tasks. Natural Language Processing (NLP) is used and based on deep learning by the bots. Deep learning can be accomplished by one of a multitude of methods known in the art.

In an embodiment, business employees are able to monitor both the chat room and artificial intelligence bot answers. This would allow business employees to intervene if either group is transmitting incorrect information or to provide additional details.

In an embodiment, if the business owner decides to use the businesses own AI Bots as external Bots for security or any other external third party Bots, the application will behave as the link or gateway between users and external Bots where all questions/answers will be forwarded back and forth between users and external Bots. Restful web service protocol is used in order to allow external artificial intelligence bots to be in communication with internal artificial intelligence bots. This architecture allows the internal artificial intelligence bot to be the gateway between mobile devices and external bots. Internal bots will not store and read data during the transmit for privacy reasons relating to the user.

A primary database is in communication with the main server. The primary database stores information regarding user accounts, chat rooms and other data. An internal artificial intelligence bot pool is pulling data from main database periodically for chat room configuration and assign individual chat Bot to join room accordingly. Once join the chat room, AI bots will communicate with mobile devices via Extensible Messaging and Presence Protocol (XMPP) protocol. There is also an alternate mechanism in which Bot does not need to join the chat room in advance unless there is a event happened. An event could be a question raised by users to Bot.

In an embodiment, each user is presented with the option to “check in” at a particular store or other business location. Upon checking in, the system can then accurately convey the appropriate information. This information may include customer service, promotional advertisements, or otherwise. Once the user provides their location via the “check in” feature, the user is then able to receive accurate information from each business in a user-selected vicinity.

In an embodiment, the external bot will send information to the internal bot. The internal bot acts as an intermediary between the user, the users external bot and the system.

Each user is able to set a search result radius. This feature allows each user to filter the target search result. For example, the user may be at a shopping mall that has a multitude of stores. The user could then select to only search stores within a ¼ mile of their location to yield results that are in the shopping mall. This allows the user to chat with other members of the community whom are in the ¼ mile specified radius, and share information regarding products, promotions, fastest lines in department stores, and any other questions they may have. The user will have access to all chats, chat rooms, and artificial intelligence bots related to businesses in the specified range.

In an embodiment, a core principle of the software application is to provide instant and accurate customer service to consumers who are physically in the store. While shopping, the user can interact with other users, or the artificial intelligence bot associated with the business. For example, the user may be shopping for a shirt and realize there are no large sizes on the shelf. The user could then communicate with a bot and ask if there are additional inventory, or perhaps the correct size at a different business location. Users can also ask in a chat room if additional sizes are available at another store in the mall. To accomplish this, data is sent from the device to the AI Bot which is assigned exclusively to that room. The bot will process the input text and decide the best answer based on previous data in the Bot database or predefined AIML (Artificial Intelligence Markup Language) file. If the input is requesting inventory data, the AI Bot will access the user database to complete the answer. If the internal AI Bot is a relay bot, it will forward request to the external AI Bot as a Restful web service request and relay the answer back to the device in order to answer the users question. The user can also raise the question in the business chat room and get feedback from other users in the same room.

In reference to FIG. 2, a method comprising the step of 10-45 is shown. In step 10, the software geolocates one or more devices and in step 20, the user verifies the geolocation of the one or more devices. In step 25, the user selects a search proximity based on the geolocation of the one or more devises. One or more businesses are identified by the one or more devices based on the search proximity. Step 30 upon receiving these results, a list is presented containing businesses that fit the search parameters. In step 35, the user selects at least one of the of the one or more businesses. In step 40, the one or more devices communicates with a first network within the selected business. In an embodiment, the first network is a social network or chat room wherein the user may engage with other users. In step 45, the first network presents one or more chat rooms wherein each user may engage. The first network then communicates with a second network. The second network comprises the artificial intelligence bots that are able to adapt to the users input and respond to the users within the network.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1) A customer service method comprising the steps of:
a) geolocating one or more devices;
b) verifying the geolocation of the one or more devices by a user;
c) selecting a search proximity based on the geolocation of the one or more devices, wherein one or more businesses are identified by the one or more devices based on the search proximity;
d) presenting a list of the one or more businesses;
e) the user selecting at least one of the one or more businesses;
f) the one or more devices communicating with a first network within the selected business; and
g) the first network presenting one or more chat rooms displayed on the one or more devices, wherein the user engages the one or more chat rooms, wherein the one or more chat rooms communicates information to a second network, wherein the second network is adaptive, wherein the second network adapts based on user input, wherein the second network responds to the engagement from the user.

2) The method of claim 1, wherein at least one user is a manager, wherein the manager is auditing the second network response.

3) The method of claim 1, wherein the second network is searching a product inventory, wherein one or more results of the search are displayed on the one or more devices.

4) The method of claim 1, wherein the second network is searching a business information list, and displaying one or more results of the search on the one or more devices.

5) The method of claim 1, wherein the search proximity is adjustable by the one or more devices.

6) The method of claim 5, wherein the search proximity has a maximum radius of 25 miles relative to the one or more devices.

7) The method of claim 1 comprising:
a) a main server, wherein the main server is in communication with the one or more devices, wherein the main server is in communication with one or more main databases, and wherein the main server is in communication with the first and second network;
b) a main database, wherein the main database is in communication with the main server;
c) an internal artificial intelligence bot, wherein the internal artificial intelligence bot is in communication with a bot database, wherein the internal artificial intelligence bot is in communication with the main server, wherein the internal artificial intelligence bot is in communication with the one or more devices; and
d) an external artificial intelligence bot, wherein the external artificial intelligence bot is in communication with the internal artificial intelligence bot.

8) The method of claim 1, wherein the internal artificial intelligence bot is communicating with the device using an Extensible Messaging and Presence Protocol.

9) The method of claim 1, wherein the one or more chat rooms are created by a business.

10) The method of claim 1, wherein the one or more chat rooms are created by a consumer.

11) The method of claim 1, wherein the internal artificial intelligence bot uses Natural Language Processing for communication between the one or more devices.
